(19) United States
(12) Patent Application Publication
(10) Pub. No.: US 2018/0164779 A1
(43) Pub. Date: Jun. 14, 2018

(54) METHOD, SERVER, AND PROGRAM FOR PROVIDING REAL-TIME ROBOT MONITORING SERVICE

(71) Applicant: QNT Co., Ltd., Ulsan (KR)

(72) Inventor: Jae Eun KIM, Ulsan (KR)

(21) Appl. No.: 15/821,819

(22) Filed: Nov. 23, 2017

(30) Foreign Application Priority Data
Dec. 13, 2016 (KR) 10-2016-0169720
Dec. 13, 2016 (KR) 10-2016-0169721
Jun. 27, 2017 (KR) 10-2017-0081366
Jun. 27, 2017 (KR) 10-2017-0081367

(51) Int. Cl. G05B 19/4063

(52) U.S. Cl. CPC G05B 19/4063; G05B 2219/50185; G05B 2219/42271; G05B 2219/39005

(57) ABSTRACT

Provided is a method of providing a real-time robot monitoring service, in which robots in a factory are monitored in real-time by a service providing server, the method including steps of: (a) receiving state information of each axis of each of the robots from a robot controller; (b) generating preventive measure information which is related to a management state of the robot and predictive measure information which is related to a process capability of the robot and a state change pattern of the robot by analyzing the state information of each of the axes of the robot; and (c) transmitting the preventive measure information of each of the axes and the predictive measure information of each of the axes to a manager terminal of the factory.

### CROSS-REFERENCE TO RELATED APPLICATION

This application claims priority to and the benefit of Korean Patent Application No. 2016-0169720, 2016-0169721, 2017-0081366 and 2017-0081367, respectively filed on Dec. 13, 2016, Dec. 13, 2016, Jun. 27, 2017 and Jun. 27, 2017, the disclosure of which is incorporated herein by reference in its entirety.

### BACKGROUND

### 1. Field

The present disclosure relates to a method, server, and program for providing a real-time robot monitoring service, and more particularly, to a method, service, and program capable of saving a robot maintenance cost of factories and improving system stability and reliability by allowing a service providing server to monitor a plurality of robots held by various factories in real-time such that a defect in the robots or a system abnormality is detected at an early stage and a possible failure is predicted and repaired.

### 2. Discussion of Related Art

Nowadays, for quality improvement and productivity assurance in a factory, a large number of industrial robots that can support high-speed and large scale multi-item production are being used, and accordingly, a great amount of cost is taken to maintain and manage the robots.

In addition, when an unexpected failure occurs, production is abruptly stopped, it leads to a negative effect in that factory productivity and product quality are degraded, which causes a huge amount of loss.

In particular, vehicle manufacturing factories may end up with a great financial loss in the event of an abrupt failure in a robot. In order to remove such a constraint, there is an increasing need for a technology of monitoring a state of a robot in real time and predicting a failure by securing an appropriate maintenance strategy.

### SUMMARY

The present disclosure is directed to a technology in which a service providing server analyzes individual pieces of state information of a plurality of robots that are acquired through an Internet of things (IoT) sensor in real-time such that defects in the robots and a system abnormality are detected at an early stage and a possible failure is predicted and addressed, thereby saving loss of a factory and improving stability and reliability of a system.

The present disclosure is directed to a technology in which, when analyzing a state of each robot, a service providing server automatically learn a state change pattern of the robot to improve service accuracy.

The present disclosure is directed to a technology in which a service providing server collectively monitors a plurality of robots held by a plurality of factories and provides each of the factories with a program in which the statuses of the robots are identified to save robot management costs of factories and improve convenience of management.

The technical objectives of the present disclosure are not limited to the above, and other objectives may become apparent to those of ordinary skill in the art based on the following descriptions.

According to one aspect of the present disclosure, there is provided a method of providing a real-time robot monitoring service, in which robots in a factory are monitored in real-time by a service providing server, the method including steps of: receiving state information of each axis of each of the robots from a robot controller; generating preventive measure information which is related to a management state of the robot and predictive measure information which is related to a process capability of the robot and a state change pattern of the robot by analyzing the state information of each of the axes of the robot; and transmitting the preventive measure information of each of the axes and the predictive measure information of each of the axes to a terminal of a manager of the factory.

The preventive measure information may include information related to at least one of a management state of each of the axes, a replacement recommended cycle of each of the axes, a latest part replacement date of each of the axes, and a remaining duration of each of the axes.

The predictive measure information may include information related to at least one of a state change tendency of each of the axes, a process capability rank of each of the axes, a remaining useful life of each of the axes, and a state change pattern of each of the axes.

The process capability rank may be assessed for each of the axes of the robot on the basis of a Zst value and a Zshift value of each of the axes calculated on the basis of the state information of each of the axes according to a predetermined process capability rating criterion.

The process capability rating criterion may assess different process capability ranks within predetermined ranges of the Zst values and Zshift values such that a larger Zst value and a smaller Zshift value are assigned a higher process capability rank.

The process capability rating criterion may be updated according to on-site information when the on-site information is received from the terminal of the manager.

Step (b) may further include, when the state change pattern is different from existing pattern information, learning a new state change pattern and allowing the new state change pattern to be used to analyze the state information of each of the axes.

Step (b) may further include determining a corrective action according to a result of analyzing the state information of each of the axes, and step (c) may further include transmitting the corrective action to the terminal of the manager.

Step (b) may further include analyzing a cause and an action plan corresponding to an alarm signal received from the robot controller; and step (c) may further include transmitting information about the cause and the action plan corresponding to the alarm signal of the robot controller to the terminal of the manager of the factory.

Step (c) may further include processing the preventive measure information and predictive measure information of each of the axes into a form of at least one of a graph or spreadsheet data.

According to another aspect of the present disclosure, there is provided a service providing server for monitoring robots in a factory in real time, the service providing server including: a robot related information acquirer configured to receive state information of each axis of each robot from a robot controller; a robot state diagnoser configured to generate preventive measure information which is related to a management state of the robot and predictive measure information which is related to a process capability and a state change pattern of the robot by analyzing the state information of each of the axes of the robot; and a monitoring information provider configured to transmit the preventive measure information of each of the axes and the predictive measure information of each of the axes to a terminal of a manager of the factory.

The robot state analyzer may be configured to, when the state change pattern is different from existing pattern information, learn a new state change pattern and allow the new state change pattern to be used to analyze the state information of each of the axes in the future.

The robot state diagnoser may determine a corrective measure according to a result of analyzing the state information of each of the axes, and the monitoring information provider may transmit the corrective action to the terminal of the manager.

The robot state diagnoser may analyze a cause and an action plan corresponding to an alarm signal received from the robot controller; and the monitoring information provider may transmit information about the cause and the action plan corresponding to the alarm signal of the robot controller to the terminal of the manager of the factory.

The monitoring information provider may provide the preventive measure information and predictive measure information of each of the axes into a form of at least one of a graph or spreadsheet data.

According to another aspect of the present disclosure, there is provided a computer program stored in a recording medium to execute, in combination with a robot user terminal and a robot manufacturer terminal, steps of: receiving state information of each axis of each robot from a robot controller; generating preventive measure information which is related to a management state of the robot and predictive measure information which is related to a process capability the robot and a state change pattern of the robot by analyzing the state information of each of the axes of the robot; and transmitting the preventive measure information of each of the axes and predictive measure information of each of the axes to the robot user terminal and the robot manufacturer terminal.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a schematic diagram illustrating a configuration of a system for providing a real-time robot monitoring service according to an embodiment of the present disclosure.

FIG. 2 is a block diagram illustrating a configuration of a service providing server according to an embodiment of the present disclosure.

FIG. 3 is a flowchart showing a process of a real-time robot monitoring service provided according to an embodiment of the present disclosure.

FIG. 4 is a diagram illustrating a robot process capability rating criterion according to an embodiment of the present disclosure.

FIG. 5 is a diagram illustrating a robot process capability rating criterion for each state of a robot, which is adjusted on the basis of on-site information, according to an embodiment of the present disclosure.

FIG. 6 is a diagram illustrating an example of a real-time robot monitoring program screen in which various types of alarm signals and information about individual robots may be checked according to an embodiment of the present disclosure.

FIG. 7 is a diagram illustrating an example of a real-time robot monitoring program screen in which a state of each axis of a robot may be checked according to an embodiment of the present disclosure.

FIG. 8 is a diagram illustrating an example of a real-time robot monitoring program screen in which preventive measure information of a robot may be checked according to an embodiment of the present disclosure.

FIG. 9 is a diagram illustrating an example of a real-time robot monitoring program screen in which state change tendency information of each axis of a robot may be checked according to an embodiment of the present disclosure.

### DETAILED DESCRIPTION OF EXEMPLARY EMBODIMENTS

Hereinafter, embodiments of the present disclosure will be described in detail with reference to the accompanying drawings. The present disclosure may be embodied in various ways and is not to be construed as limited to the embodiments set forth herein. In the drawings, parts irrelevant to the description have been omitted for the clarity of explanation. In the drawings, the same parts throughout the drawings will be assigned the same number, and redundant descriptions thereof will be omitted.

It should be understood that, when an element is referred to as being “connected to” or “coupled to” another element, the element can be directly connected or coupled to the other element, or an intervening element may be present. Conversely, when an element is referred to as being “directly connected to” or “directly coupled to” another element, there are no intervening elements present.

Hereinafter, embodiments of the present disclosure will be described in detail with reference to the accompanying drawings.

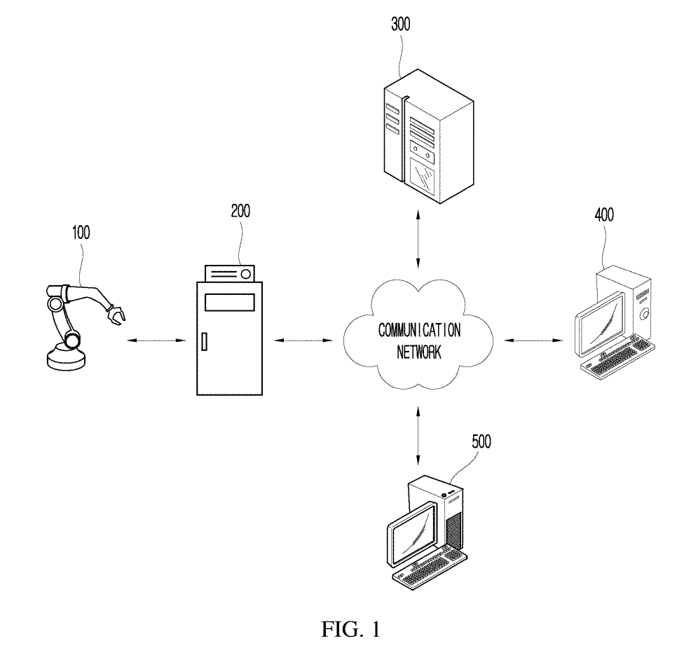

FIG. 1 is a schematic diagram illustrating a configuration of a system for providing a real-time robot monitoring service according to an embodiment of the present disclosure.

Referring to FIG. 1, a system for providing a real-time robot monitoring service according to an embodiment of the present disclosure includes a robot 100, a robot controller 200, a service providing server 300, a robot user terminal 400, and a robot manufacturer terminal 500.

The service providing server 300, the robot user terminal 400, and the robot manufacturer terminal 500 may be implemented as a recording medium that is operated through a computer program configured to implement functions that will be described in this specification.

Although the following description will be made in relation to an embodiment in which the robot 100, the robot controller 200, the service providing server 300, the robot user terminal 400, and the robot manufacturer terminal 500 are each provided in a single unit, the present disclosure is not limited thereto. For example, each of the robot 100, the robot controller 200, the service providing server 300, the robot user terminal 400, and the robot manufacturer terminal 500 may be provided in a plurality of units to form the system for providing a real-time robot monitoring service.

First, the robot 100, the robot controller 200, the service providing server 300, the robot user terminal 400, and the robot manufacturer terminal 500 are connected via a communication network. The communication network may be implemented regardless of communication manner, such as a wired manner or wireless manner. The communication network may be implemented in various communication networks, e.g., a local area network (LAN), a metropolitan area network (MAN), a wide area network (WAN), and the like.

The robot 100 may be a device that is installed in a factory to perform a particular task program designated by the robot controller 200.

The robot 100 according to an embodiment may be constituted by a plurality of axes including various parts, and may be provided with sensor devices configured to measure temperature, vibration, noise, and the like of each of the axes.

The robot controller 200 may be a device that controls an operation of the robot 100 and periodically collects state information of the robot 100 while communicating with the robot 100.

The state information of the robot 100 may include at least one of motor operation information, reducer operation information, encoder operation information, temperature information, vibration information, noise information, and the like that are measured for each of the axes of the robot 100 connected to the robot controller 200.

In addition, the robot controller 200 may collect model information, serial number information, manufacturing date information, installation date information, installed sub-line information, IP address information, executed task information, and the like from the robot 100 as unique information of the robot 100 connected thereto.

The robot controller 200 according to an embodiment may transmit the acquired unique information and state information of the robot 100 to the service providing server 300, and may transmit various alarm signals generated on the basis of a criterion that it sets itself.

According to another embodiment of the present disclosure, the robot 100 may include a data acquisition board device capable of communicating with an external server, and may acquire own unique information and state information of the robot 100 in an analog form, convert the acquired unique information and state information into a digital form of information through the data acquisition board, and transmit the information to the service providing server 300.

According to another embodiment of the present disclosure, the system for providing a real-time robot monitoring service may include a factory server (not shown) which is a server operated by a factory holding one or more robots 100, and the factor server may acquire the unique information and state information of the robot 100 through the robot controller 200 and transmit the acquired unique information and state information of the robot 100 to the service providing server 300.

In this case, the factory server may acquire manager information about a manger who manages the factory and the robot 100, robot status information, which is information about a status of the robots 100 held by the factory, spare part status information, which is information about a status of spare parts of components constituting the robot 100, maintenance history information, which is information about details of checks and or repairs performed on the robot 100 by the manager, and the like on its own, or may receive the manager information, the robot status information, the spare part status information, the maintenance history information, and the like from the manager through the robot user terminal 400 or the robot manufacturer terminal 500 as information related to the factory so that the manager information, the robot status information, the spare part status information, the maintenance history information, and the like are transmitted to the service providing server 300.

In addition, the factory server may receive information about a result obtained by analyzing a state of the robot 100 and various alarm signals related to maintenance of the robot 100 from the service providing server 300 and transmit the result information and the various alarm signals to the robot user terminal 400 or the robot manufacturer terminal 500.

The service providing server 300 may be a server that operates a real-time robot monitoring service by registering information about a factory, to which a real-time robot monitoring server is desired to be provided, in an internal database and analyzing and processing the received information related to the robot 100.

According to an embodiment, the service providing server 300 may receive various pieces of information related to factories from respective managers through the robot user terminal 400 and the robot manufacturer terminal 500 so that the factories are registered as objects to which a service is to be provided.

In addition, the service providing server 300 may manage a spare part status of the factory on the basis of the information about the registered factory.

The service providing server 300 according to an embodiment of the present disclosure may receive information about a manager who will use the system from the robot user terminal 400 or the robot manufacturer terminal 500, and, on the basis of the information about the manager, may register the manager in the internal database and manage the manager.

On the basis of the unique information and state information of the robot 100 that are periodically received from the robot controller 200, the service providing server 300 may register the robot 100 in the internal database such that the robot 10 matches the factory in which the robot 100 is disposed.

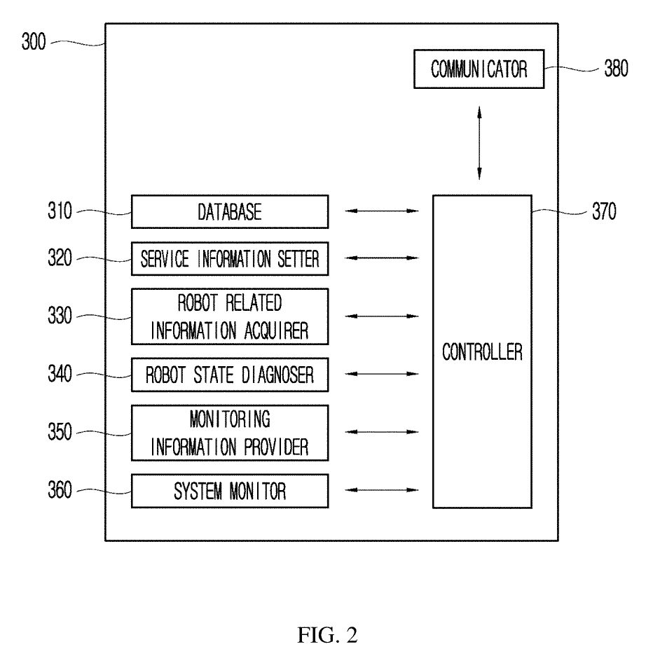

The service providing server 300 according to an embodiment may set criterion information for analyzing the state information of the robot 100, analyze and process the state information of the robot 100 according to the criterion information, generate preventive measure information and predictive measure information of the robot 100, and transmit an alarm related to the preventive measure information and predictive measure information to the robot user terminal 400 or the robot manufacturer terminal 500. Details thereof will be described below with reference to FIG. 2.

According to an embodiment, the service providing server 300 may be configured to analyze a cause and an action plan for an alarm signal when the alarm signal is received from the robot controller 200.

In addition, the service providing server 300 may be configured to backup executed task information of the robot 100 on the internal database when the executed task information of the robot 100 is received from the robot controller 200, and manage an executed task error history of the robot 100 on the basis of the backed up information.

The service providing server 300 may manage information and interface graphics displayed on the robot user terminal 400 or the robot manufacturer terminal 500 through a real-time robot monitoring program, and when changes thereof occur, update the real-time robot monitoring program corresponding to the information and interface graphics through a web server (not shown).

The robot user terminal 400 may be a terminal used by a manager who manages a factory which produces a product by using the robot 100, and the robot manufacturer terminal 500 may be a terminal used by a manager who manages a robot manufacturer which manufactures the robot 100 being used by a robot user.

The robot user terminal 400 or the robot manufacturer terminal 500 may download a real-time robot monitoring program allowing the real-time robot monitoring service from the service providing server 300 through a separate web server (not shown) according to a manipulation of the respective manager and install the downloaded real-time robot monitoring program in an internal memory.

The robot user terminal 400 and the robot manufacturer terminal 500 may include all types of handheld wireless communication devices that may be connected to an external server, such as the service providing server 300, via a network, for example, a mobile phone, a smart phone, a personal digital assistant (PDA), a portable multimedia player (PMP), a tablet personal computer (tablet PC), and the like. In addition, the robot user terminal 400 and the robot manufacturer terminal 500 may include a communication device to be connected to an external server, such as the service providing server 300, via a network, for example, a desktop PC, a tablet PC, a laptop PC, and an Internet protocol television (IPTV) including a set top box.

FIG. 2 is a block diagram illustrating a configuration of the service providing server 300 according to an embodiment of the present disclosure.

Referring to FIG. 2, the service providing server 300 may include a database 310, a service information setter 320, a robot related information acquirer 330, a robot state diagnoser 340, a monitoring information provider 350, a system monitor 360, a controller 370, and a communicator 380.

The database 310 may be configured to store various types of information related to a real-time robot monitoring service according to the present disclosure.

According to an embodiment, the database 310 may be configured to store information about a factory of a robot user and a robot manufacturer, which is an object to which the real-time robot monitoring service is to be provided (a name of the factory, an identification code of the factory, a spare part stock status of the factory, and the like), information about a production line of the factory (a name of the production line, an identification code of the production line, and the like), information about each sub-line (a name of the sub-line, an identification code of the sub-line, an order of the sub-line, and the like), information about a manager (ID information of the manager, password information of the manager, name information of the manager, division information of the manager, position information of the manger, and the like).

In addition, according to an embodiment, the database 310 may be configured to store the unique information of the robot 100 received from the robot controller 200 (model information of the robot 100, serial number information of the robot 100, manufacturing date information of the robot 100, installation date information of the robot 100, installed sub-line information of the robot 100, IP address information of the robot 100, executed task information of the robot 100, and the like), and state information (motor operation information of each axis of the robot 100, reducer operation information of each of the axes, encoder operation information of each of the axes, temperature information of each of the axes, vibration information of each of the axes, noise information of each of the axes, and the like) received from the robot controller 200, and may further store criterion information for analyzing the state information of the robot 100 and result information obtained by completing analysis.

According to an embodiment, the database 310 may store a previous state information analysis history and a previous failure history for the robots 100 such that information enabling an analyzer to identify which state information has a high chance of failure may be provided.

Accordingly, the robot state diagnoser 340 may determine the remaining useful life or the occurrence of a failure by only receiving state information about the robot 100 through big data analysis and the like.

The service information setter 320 may register information related to a factory, which is an object to which the real-time robot monitoring service is to be provided, and may set a criterion for analyzing the state information of the robot 100.

In detail, the service information setter 320 may receive a service registration request including factory information of each of the robot user and the robot manufacturer, production line information of each factory, sub-line information of each of the factories, and manager information of each of the factories from the robot user terminal 400 and the robot manufacturer terminal 500.

Accordingly, the service information setter 320 may register the robot user and the robot manufacturer in the database 310 as an object to which the real-time robot monitoring service is to be provided on the basis of the service registration request.

The information may be corrected when requests to update the information about the robot user and the robot manufacturer are received from the robot user terminal 400 and the robot manufacturer terminal 500, respectively.

According to an embodiment, the service information setter 320 may receive the unique information of the robot 100 from the robot controller 200.

Accordingly, the service information setter 320 may register the robot 100 in the database 310 according to the unique information by matching the robot 100 and a sub-line in which the robot 100 is installed and generating a specification item corresponding to a model of the robot 100.

The service information setter 320 according to an embodiment of the present disclosure may set a criterion for calculating a process capability rank of each of the axes of the robot 100 or determining a management state of the robot 100 in the robot state diagnoser 340. For example, the service information setter 320 may set a criterion with respect to upper and lower limits of a motor load factor, an encoder temperature, a continuous load factor, a reducer torque, vibration, noise, and reducer lifespan of each of the axes, and may set a state diagnosis cycle of the robot 100 and a state information acquisition cycle of the robot 100.

According to an embodiment, the criterion for diagnosing the state of the robot 100 may be input from a manager who manages the service providing server 300, or may be set according to information received from the robot user terminal 400 or the robot manufacturer terminal 500.

The robot related information acquirer 330 may acquire state information of the robot 100, maintenance execution information of the robot 100, spare part stock status information of the robot 100, and the like.

In detail, the robot related information acquirer 330 may receive state information of each of the axes of the robot 100 from the robot controller 200, and store the received state information in the database 310 on the basis of reception time at which the state information is received.

In addition, according to an embodiment of the present disclosure, the robot controller 200 may generate an alarm signal by itself with regard to an on-site state of the factory or a state of the robot 100, and the robot related information acquirer 330 may receive the alarm signal of the robot controller 200 from the robot controller 200.

The robot related information acquirer 330 according to an embodiment may receive information related to the factory corresponding to each of the robot user terminal 400 or the robot manufacturer terminal 500 (status information of spare parts held by the factory, information about maintenance executed on the robot 100 in the actual factory, and the like), and store the received information in the database 310, and, when a change occurs, update the stored information.

In this case, according to an embodiment of the present disclosure, the robot related information acquirer 330 may allow the service information setter 320 to adjust the criterion for diagnosing a state of the robot 100 according to the maintenance execution information of the robot 100.

In detail, the manager may execute maintenance on the robot 100 in the actual factory according to an alarm signal provided by the monitoring information provider 350, but the state of the robot 100 may be found to be different from a state corresponding to the alarm signal.

In this case, the robot user terminal 400 or the robot manufacturer terminal 500 may receive on-site information about the robot 100 from the manager of the robot user terminal 400 or the robot manufacturer terminal 500, that is, information about a axis on which maintenance is executed, process capability rank information for the axis provided from the service providing server 300, and actual process capability rank information which is checked on-site, and may transmit the received information to the robot related information acquirer 330 such that the criterion for diagnosing a state of the robot 100 is adjusted by the service information setter 320 according to the on-site information.

The robot state diagnoser 340 may analyze the information acquired through the robot related information acquirer 330 on the basis of the analysis criterion set by the service information setter 320, and may store a result of the analysis in the database 310.

In detail, the service information setter 320 may calculate a process capability rank of each of the axes of the robot 100 or determine a management state thereof with reference to the state information.

According to an embodiment, the robot state diagnoser 340 may calculate at least one of a motor load factor, an encoder temperature, a reducer remaining useful life, a continuous load factor, a reducer torque, and the like for each of the axes on the basis of motor operation information, reducer operation information, encoder operation information, temperature information, vibration information, noise information, and the like of each of the axes of the robot 100.

In addition, the robot state diagnoser 340 may assess a process capability rank of each of the axes of the robot or determine the management state thereof to be one of a normal state, a replacement recommended state, and a passed state according to the calculated result.

For example, an upper limit lifespan and a lower limit lifespan of a reducer set by the service information setter 320 may be six months and three months, respectively. In this case, as a result of analyzing the state information of the robot 100 in the robot state diagnoser 340, a reducer located on a first axis of the robot 100 may have a remaining useful life of two months and a reducer located on a second axis of the robot may have a remaining useful life of four months. In this case, the robot state diagnoser 340 may assess the process capability of the first axis as a 5^{th} rank and may assess the process capability of the second axis as a 3^{rd} rank higher than that of the first axis, or may determine the management state of the first axis as the passed state indicating that a part replacement time is passed and may determine the management state of the second axis to the replacement recommended state indicating that part replacement is recommended.

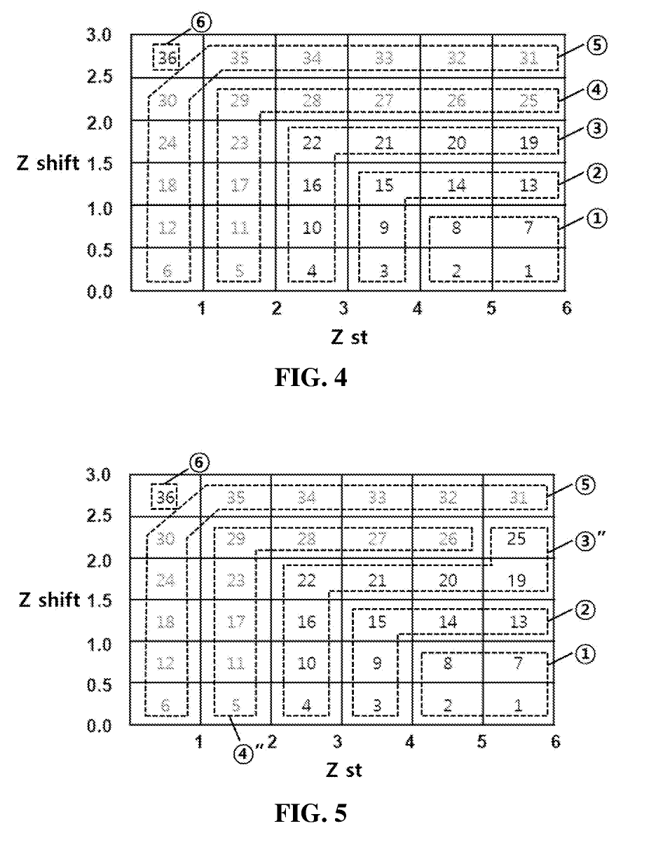

The process of assessing a process capability rank of each of the axes will be described in detail below with reference to FIG. 4.

According to an embodiment of the present disclosure, the robot state diagnoser 340 may determine a corrective action needed based on the rank of each of the axes of the robot 100, an overall process capability rank of the robot 100 itself determined in consideration of the process capability rank of each of the axes of the robot 100, or the management state.

According to an embodiment of the present disclosure, when a process capability rank of a particular axis or the overall process capability rank of the robot 100 is a 1^{st} rank or a 2^{nd} rank, the robot state diagnoser 340 may determine that the particular axis or the robot is be in the normal state, and thus may send the robot user terminal 400 or the robot manufacturer terminal 500 an alarm signal informing that the particular axis or the robot is determined to be in the normal state.

In addition, according to an embodiment, when the process capability rank of the particular axis or the overall process capability rank of the robot 100 is assigned to the 3^{rd} rank, the robot state diagnoser 340 may determine that the particular axis or the robot 100 is not at risk of an immediate failure but it is necessary to pay attention and check a spare part stock status and maintenance history of the particular axis or the robot 100 by referring to the information related to the factory received through the robot related information acquirer 330.

In this case, the robot state diagnoser 340 may send the robot user terminal 400 or the robot manufacturer terminal 500 an alarm signal indicating that it is necessary to supplement a spare part when the spare part stock status is below a predetermined number, and an alarm signal indicating that it is necessary to refurbish the particular axis or the robot 100 when a predetermined period of time elapses from the latest maintenance date according to the maintenance history.

In addition, when the process capability rank of the particular axis or the robot 100 is assigned to a 4^{th} rank or the 5^{th} rank, the robot state diagnoser 340 determines that the particular axis or the robot 100 is at risk of failure, and thus may send the robot user terminal 400 or the robot manufacturer terminal 500 an alarm signal requesting part replacement and maintenance for the robot.

According to an embodiment, when the process capability rank of the particular axis or the robot 100 is assigned to a 6^{th} rank, the robot state diagnoser 340 determines that the particular axis or the robot 100 is in a bad state and requires an urgent measure, and thus may send the robot user terminal 400 or the robot manufacturer terminal 500 an alarm signal requesting that the robot 100 be stopped immediately and maintained.

In addition, according to an embodiment of the present disclosure, the robot state diagnoser 340 may calculate a part replacement recommended cycle for each of the axes of the robot 100 according to a result of analyzing the state information of the robot 100, and may calculate a duration thereof remaining until a replacement date on the basis of the maintenance execution information of the robot 100 stored in the database 310.

In detail, the robot state diagnoser 340 according to an embodiment may calculate a remaining useful life of each of the axes of the robot 100 by analyzing the state information of the robot 100 to compile statistics on a state change tendency of each of the axes of the robot 100, and may derive a state change pattern by extracting a quality factor of each of the axes.

In this case, according to an embodiment, when it is found that on-site information, which is information indicating that the state of the robot 100 in the actual factory is different from the state determined by the service providing server 300, is stored as a history in the database 310 through the robot related information acquirer 330, the robot state diagnoser 340 may further refer to the on-site information when analyzing the state change pattern of each of the axes.

In addition, according to an embodiment, when the derived state change pattern is different from the existing pattern information, the robot state diagnoser 340 may learn the newly derived state change pattern and may apply the learned state change pattern to the analysis of the state of the robot 100 in the future so that quality and accuracy of the real-time robot monitoring service may be improved.

Then, on the basis of the analyzed state change pattern of each axis of the robot 100, the robot state diagnoser 340 may determine a part replacement time of each of the axes by predicting a state change tendency of each of the axes of the robot 100 desired to be currently inspected and may calculate the duration remaining until the part replacement time with reference to the latest maintenance execution information.

The robot state diagnoser 340 according to an embodiment of the present disclosure may be configured to determine a cause and an action plan for an alarm signal of the robot controller 200 when the alarm signal of the robot controller 200 is received through the robot related information acquirer 330.

For example, the robot related information acquirer 330 may receive an alarm signal indicating that an operation of a first robot is stopped from the robot controller 200, and, in this case, the robot state diagnoser 340 may check state information of the first robot, identify a cause of the stoppage, determine an action plan suitable for the stoppage, and instruct a manager terminal of the corresponding factory about the action plan.

According to an embodiment, the action plan may be input from a manager who manages the service providing server 300, and may be set according to information received from the robot user terminal 400 or the robot manufacturer terminal 500.

Then, the robot state diagnoser 340 may store a history of the generated alarm signal of the robot controller 200 in the database 310.

The monitoring information provider 350 may provide the robot user terminal 400 and the robot manufacturer terminal 500 with information resulting from the monitoring of the factory related information by the service providing server 300 and information resulting from the analyzing of the state information of the robot 100 by the robot state diagnoser 340 through the real-time robot monitoring program.

That is, the service providing server 300 collectively monitors a plurality of robots held by factories, and provides each of the factories with the status through the real-time robot monitoring program to save robot management cost of factories and improving convenience of management.

In detail, the monitoring information provider 350 may send the robot user terminal 400 and the robot manufacturer terminal 500 information about the robots 100 disposed over a whole production line and sub-lines in the factory and the state information of the robot 100 such that the information is displayed on each of the robot user terminal 400 and the robot manufacturer terminal 500.

In addition, the monitoring information provider 350 may compile statistics on the state information of the robot 100 acquired through the robot related information acquirer 330 and the motor load factor, the encoder temperature, the reducer remaining useful life, the continuous load factor, the reducer torque, and the like for each of the axes calculated through the robot state diagnoser 340, and process the compiled statistics into a graph, spreadsheet data and the like.

Accordingly, the monitoring information provider 350 may transmit the graph or spreadsheet data to the robot user terminal 400 and the robot manufacturer terminal 500 such that the graph and spreadsheet data are displayed on screens of the terminals.

In addition, the monitoring information provider 350 may send the robot user terminal 400 and the robot manufacturer terminal 500 an alarm signal corresponding to the current state of the robot diagnosed through the robot state diagnoser 340. For example, when a current rank of the first axis of the robot 100 is the 3^{rd} rank, a signal for recommending part replacement and maintenance for the first axis may be transmitted to the manager terminal of the factory.

According to an embodiment, the monitoring information provider 350 may generate schedule information and a schedule error history of the robot 100 by referring to the executed task information of the robot 100 stored in the database 310, and may transmit the generated schedule information and schedule error history of the robot 100 to the robot user terminal 400 and the robot manufacturer terminal 500 such that the generated schedule information and schedule error history of the robot 100 are displayed on the terminals or displayed through word processor programs, such as a notepad application.

According to an embodiment, the monitoring information provider 350 may periodically monitor the spare part stock status of the factory by referring to the status information of spare parts held by the factory that is stored in the database 310 and the maintenance execution information about the robot 100 in the actual factory, and may provide the robot user terminal 400 and the robot manufacturer terminal 500 with information about the latest receiving date of each spare part and information about a remaining quantity of each of the spare parts.

That is, the service providing server 300 may analyze individual pieces of state information of the robots in real time through the above-described process performed by the robot state diagnoser 340 and the monitoring information provider 350 so that defects in the robots and a system abnormality are detected at an early stage, a possible failure is predicted, and maintenance is performed on the factory floor to save loss of the factory.

The system monitor 360 may monitor operation of the service providing server 300, a display status of the real-time robot monitoring program, whether an error occurs, and the like in real-time

Accordingly, when an error occurs during operation of the service providing server 300 or when an error occurs in the real-time robot monitoring program, a cause thereof is analyzed and the cause is addressed through a server update or a program update so that system stability and reliability may be improved. The controller 370 according to an embodiment may serve to control a data flow between the database 310, the service information setter 320, the robot related information acquirer 330, the robot state diagnoser 340, the monitoring information provider 350, the system monitor 360, and the communicator 380. That is, the controller 370 according to the present disclosure may perform control such that the database 310, the service information setter 320, the robot related information acquirer 330, the robot state diagnoser 340, the monitoring information provider 350, the system monitor 360, and the communicator 380 each perform their unique functions.

The communicator 380 according to an embodiment may enable communication between the service providing server 300, an external server, and an external device. In detail, the service providing server 300 may enable the service providing server 300 to communicate with the robot controller 200, the robot user terminal 400, and the robot manufacturer terminal 500.

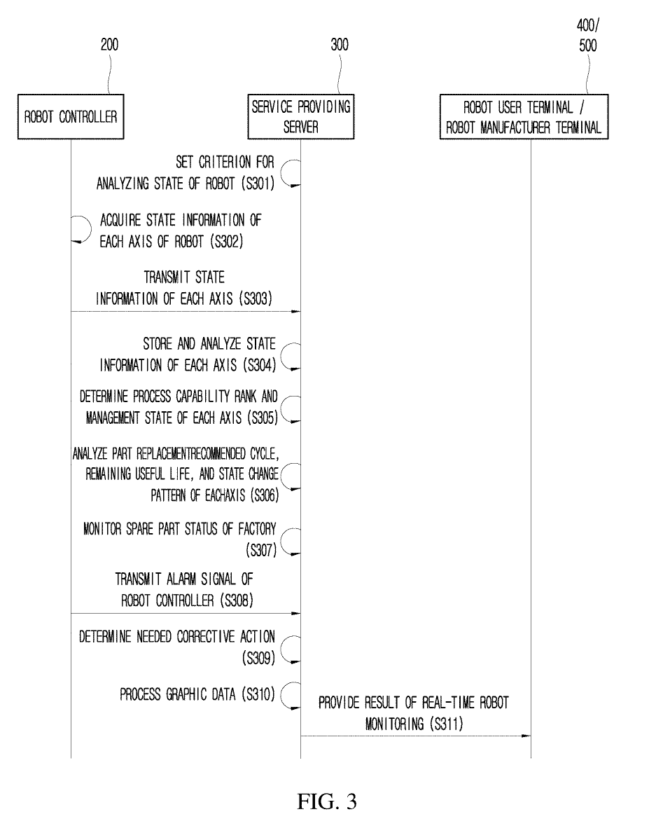

FIG. 3 is a flowchart showing a process of a real-time robot monitoring service provided according to an embodiment of the present disclosure.

First, the robot user terminal 400 and the robot manufacturer terminal 500 may have a real-time robot monitoring program previously installed therein. The service providing server 300 may have information related to a factory and information related to the robot 100, that is, an object of a real-time robot monitoring service, previously registered in the internal database, on the basis of information received from the robot controller 200, the robot user terminal 400, and the robot manufacturer terminal 500.

In this case, the information related to the factory may include at least one of information about a factory of a robot user and a factory of a robot manufacturer (a name of the factory, an identification code of the factory, a spare part holding status of the factory, and the like), information about a production line of the factory (a name of the production line, an identification code of the production line, and the like), information about each sub-line (a name of the sub-line, an identification of the sub-line, an order of the sub-line, and the like), and information about a manager (ID information of the manager, password information of the manager, division information of the manager, position information of the manger, and the like).

In addition, the information related to the robot 100 may include at least one of the unique information of the robot 100 (model information of the robot 100, serial number information of the robot 100, manufacturing date information of the robot 100, installation date information of the robot 100, installed sub-line information of the robot 100, IP address information of the robot 100, executed task information of the robot 100, and the like) and the state information of the robot 100 (motor operation information of each axis, reducer operation information of each of the axes, encoder operation information of each of the axes, temperature information of each of the axes, vibration information of each of the axes, noise information of each of the axes, and the like),

Referring to FIG. 3, the service providing server 300 may set a criterion to be used when analyzing a state of the robot 100 (S301).

The criterion may be a criterion for calculating a process capability rank of each of the axes of the robot 100 or determining a maintenance state of the robot 100. For example, the criterion may be a criterion with respect to at least one of a motor load factor, an encoder temperature, a continuous load factor, a reducer torque, and upper and lower limits of vibration, noise, and reducer lifespan of each of the axes.

According to an embodiment, the criterion for analyzing the state of the robot 100 may be input from a manager who manages the service providing server 300, or may be set according to information received from the robot user terminal 400 or the robot manufacturer terminal 500.

Then, the robot controller 200 may acquire state information of each of the axes of the robot 100 connected thereto (motor operation information, reducer operation information, encoder operation information, temperature information, vibration information, noise information, and the like) (S302), and transmit the state information to the service providing server 300 (S303).

The service providing server 300 may store the state information of each of the axes of the robot 100 received in Operation S303 in the internal database, and may analyze at least one of the motor load factor, the encoder temperature, a remaining useful life of the reducer, the continuous load factor, the reducer torque, and the like of each of the axes on the basis of the received state information of each of the axes of the robot 100 (S304).

In addition, the service providing server 300 may assess a process capability rank of each of the axes or determine a management state of each of the axes as one of the normal state, the replacement recommended state, and the passed state on the basis of the analyzed result in Operation S304 (S305), may calculate a part replacement recommended cycle and a remaining useful life, or may derive a state change pattern by extracting a quality factor of the axes (S306).

In this case, according to an embodiment, when the derived state change pattern is different from existing pattern information, the service providing server 300 may learn the newly derived state change pattern and apply the learned state change pattern to an analysis of the state of the robot 100 in the future to improve quality and accuracy of the real-time robot monitoring service.

In addition, the service providing server 300 according to an embodiment may periodically monitor information about a latest receiving date of each spare part and information about a remaining quantity of each of the spare parts of the factory by referring to the status information of the spare parts held by the factory, which is previously stored in the internal database, and the maintenance execution information about the robot 100 in the actual factory (S307).

According to an embodiment, the robot controller 200 may generate an alarm signal related to a state of a factory site or the state of the robot 100 by itself and transmit the alarm signal to the service providing server 300 (S308).

The service providing server 300 may determine a corrective action currently needed for the robot 100 according to the current state of each of the axes of the robot 100 analyzed through Operations S304 to S306, the spare part status of the factory monitored through Operation S307, and the alarm signal of the robot controller 200 received through Operation S308 (S309).

In detail, the service providing server 300 may determine an appropriate corrective action according to a rank or maintenance state of each of the axes of the robot 100, may determine a need to supplement stock according to the spare part status, and may determine a cause of the alarm signal of the robot controller 200 and an action plan for the cause.

The service providing server 300 according to an embodiment may process the results of the execution of the real-time robot monitoring performed through Operations S304 to S307 into graphic data appropriate in each result, such as a graph or spreadsheet data (S310).

Then, the service providing server 300 may provide the robot user terminal 400 and the robot manufacturer terminal 500 with the data processed through Operation S310 and an alarm signal instructing a needed corrective action determined through Operation S309 as a result of the real-time robot monitoring (S311).

Accordingly, the service providing server 300 may analyze individual pieces of state information of the robots 100 in real-time such that defects of the robots 100 and a system abnormality are detected at an early stage, a possible failure is predicted, and maintenance is performed in each factory site to save loss of the factory

FIGS. 4 and 5 are diagrams illustrating a process capability rating criterion of the robot 100 according to an embodiment.

According to an embodiment of the present disclosure, the service providing server 300 may assess a process capability rank for each of the axes of the robot 100 and an overall process capability rank of the robot 100 on the basis of the state information of the robot 100 according to a predetermined process capability rating criterion.

In detail, the service providing server 300 may calculate a Zst value, which refers to a short-term process capability, that is, technical skill, and a Zshift, which refers to a state of process management, for each of the axes of the robot 100 by converting torque information, temperature information, current information, load factor information, vibration information, noise information, and the like of each of the axes of the robot 100 into a sigma level.

Then, the service providing server 300 may assess the process capability rank of each of the axes of the robot 100 corresponding to the calculated Zst value and Zshift value according to the predetermined process capability rating criterion.

According to an embodiment, the process capability rank may be classified into the 1^{st} to 6^{th} ranks.

In detail, the 2^{st} rank and the 2^{nd} rank may indicate that the state of the robot 100 is optimal or good as a normal level, the 3^{rd} rank indicates the state of the robot 100 is an average level, the 4^{th} rank and the 5^{th} rank indicate that the state of the robot 100 is not good or is bad as a risky level, there is a possibility of failure, and maintenance is needed, and the 6^{th} rank indicates that the state of the robot 100 is very bad and an urgent measure is needed.

According to an embodiment, the service providing server 300 may assess a higher process capability rank when the Zst value is larger and the Zshift value is smaller for a particular axis of the robot 100,

For example, a first Zst value and a first Zshift corresponding to the first axis of the robot 100 may be calculated as 5.0 and 0.5, respectively, by referring to load factor information and torque information of a motor of the first axis, and a second Zst value and a second Zshift corresponding to the second axis of the robot 100 may be calculated as 0.5 and 2.0, respectively, by referring to load factor information and torque information of a motor of the second axis. Accordingly, the service providing server 300 may assess the process capability rank of the first axis as the 1^{st} rank, and the process capability rank of the second axis as the 5^{th} rank.

Then, the service providing server 300 according to an embodiment may assign a different weight to each of the axes of the robot 100 depending on a size of a reducer of the corresponding motor, and may calculate an average of the weighted values to assess an overall process capability rank, which indicates the overall state of the robot 100 itself.

For example, the process capability rank of the first axis and the process capability rank of the second axis are assessed as the 1^{st} rank and the 5^{th} rank, respectively, and may be assigned a weight of 1.0 and a weight of 0.9, respectively, according to sizes of reducers of the first axis and the second axis. Accordingly, the service providing server 300 may find an average between the 1^{st} rank, which is obtained by applying a weight of 1.0 to the 1^{st} rank which is the process capability rank of the first axis, and the 4.5^{th} rank, which is obtained by applying a weight of 0.9 to the 5^{th} rank which is the process capability rank of the second axis, to assesses the overall process capability rank of the robot 100 as the 3^{rd} rank.

For the sake of convenience in description, the following description assumes that the Zst value and the Zshift value are calculated in a range of 0 to 6 and a range of 0.0 to 3.0, respectively, and in the corresponding ranges, the process capability rank of the robot 100 is assessed as one of the 1^{st} rank to the 6^{th} rank. However, the present disclosure is not limited to thereto.

Referring to FIG. 4, in order to assess the process capability according to the state information of the robot 100, a plane coordinate system having Zst values on the x-axis and Zshift values on the y-axis may be set.

In this case, a Zst value and a Zshift value calculated for a particular axis of the robot 100 may be included in one of ranges \textcircled{1} to \textcircled{6}, corresponding to the 1^{st} rank to the 6^{th} rank so that the particular axis may be assessed at a process capability rank according to the range in which the Zst and the Zshift of the particular axis are included.

For example, with regard to the first axis of the robot 100, when the Zst value and the Zshift value are calculated as 5.5 and 2.3, respectively, and are included in the range \textcircled{3}, the service providing server 300 may assess the process capability rank of the first axis as the 3^{rd} rank, and when the Zst value and the Zshift value are included in the range \textcircled{6}, the service providing server 300 may assess the process capability rank of the first axis as the 6^{th} rank.

According to an embodiment of the present disclosure, the process capability rank assessment criteria of the robot may be adjusted on the basis of on-site information input from a manager.

For example, the service providing server 300 may calculate the Zst value and the Zshift value for the first axis of the robot 100 as 5.5 and 2.3, respectively, may assess the process capability rank thereof as the 4^{th} rank, and accordingly, transmit an alarm signal requesting a part replacement and maintenance for the first axis to the robot user terminal 400 or the robot manufacturer terminal 500. However, as a result of performing maintenance on-site in the actual factory according to the alarm signal, the state of the first axis may be found to correspond to the 3^{rd} rank. On-site information corresponding to such a result may be transmitted to the service providing server 300 through the robot user terminal 400 or the robot manufacturer terminal 500.

In this case, the service providing server 300 may change the process capability rank assessment criteria such that the Zst value and the Zshift value calculated as 5.5 and 2.3 for the first axis are assessed as the 3^{rd} rank. That is, the range of the Zst value and the Zshift value corresponding to the 3^{rd} rank may be adjusted to a range \textcircled{3}″, and the range of the Zst value and the Zshift value corresponding to the 4^{th} rank may be adjusted to a range \textcircled{4}″.

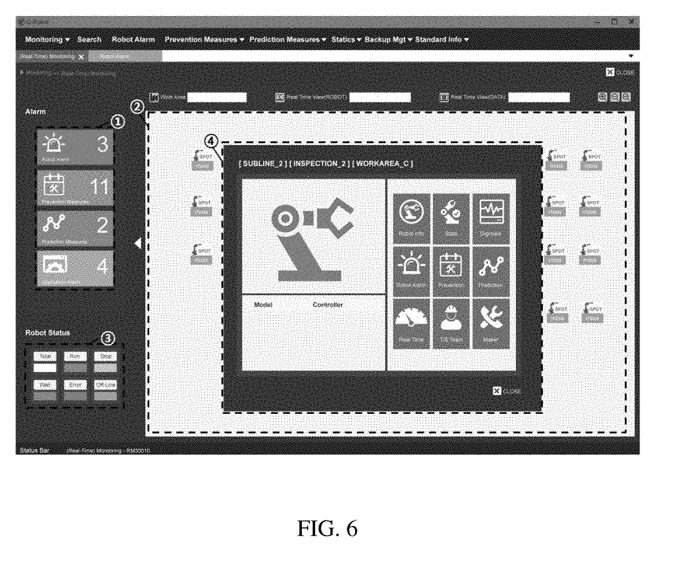

FIG. 6 is a diagram illustrating an example of a real-time robot monitoring program screen in which various types of alarm signals and information about individual robots 100 may be checked according to an embodiment of the present disclosure.

Referring to FIG. 6, the real-time robot monitoring program provides a menu in which the total amount of alarm signals provided from the service providing server 300 may be checked according to types.

A robot alarm menu may provide information related to a cause and an action plan for an alarm signal of the robot controller 200 that are identified by the service providing server 300. According to an embodiment, the information may be provided according to a type of alarms signal, and history data about alarm signals generated and canceled for the individual robot 100 may be provided.

A preventative measures menu may provide management state information, replacement recommended cycle information, latest part replacement date information, and remaining useful life information of each of the axes of the robot 100 as preventive measure information. According to an embodiment, the preventive measure information may be provided according to types of management states, and preventive measure history information may be provided according to individual robots 100.

A predictive measures menu may provide state change tendency information, process capability rank information, remaining useful life information, and state change pattern information of each of the axes of the robot 100 as predictive measure information. According to an embodiment, the predictive measure information may be provided according to process capability ranks.

An application alarm menu may provide alarm information related to the real-time robot monitoring program, such as program update information, program error occurrence information, and the like.

In addition, the real-time robot monitoring program according to an embodiment may provide a screen in which an overall layout of a factory and pieces of state information of the robots 100 may be checked, as shown in \textcircled{2}.

On the screen, graphic icons representing the robots 100 may be arranged in the same array as the robots 100 are arranged in the factory. For each of the graphic icons, a robot state-dependent color indicated in \textcircled{3} is displayed such that a manager may intuitively check the current states of the robots 100.

When the graphic icon of the robot 100 on the screen is clicked, a popup window in which the state of the robot 100 is individually identified may be provided, as in \textcircled{4}.

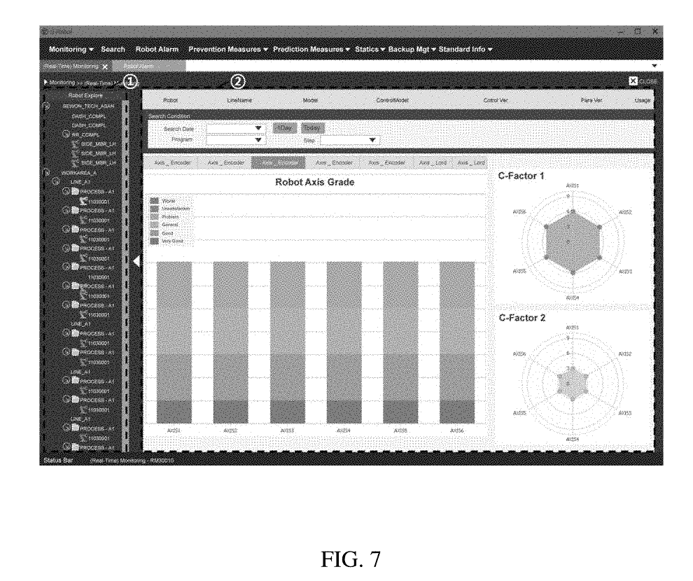

FIG. 7 is a diagram illustrating an example of a real-time robot monitoring program screen in which a state of each axis of a robot may be checked according to an embodiment of the present disclosure.

Referring to FIG. 7, the individual robot 100 disposed in a factory may be selected through a robot explore menu, as in \textcircled{1}, and state information of each of the axes of the selected robot 100 may be displayed, as in \textcircled{2}.

According to an embodiment, each of the axes of the robot 100 may be represented as AXn(n>0), and, as shown in \textcircled{2}, a process capability rank, a motor load factor, an encoder temperature, a reducer remaining useful life, a continuous load factor, a reducer torque and the like of each of the axes may be displayed in various forms of graphs.

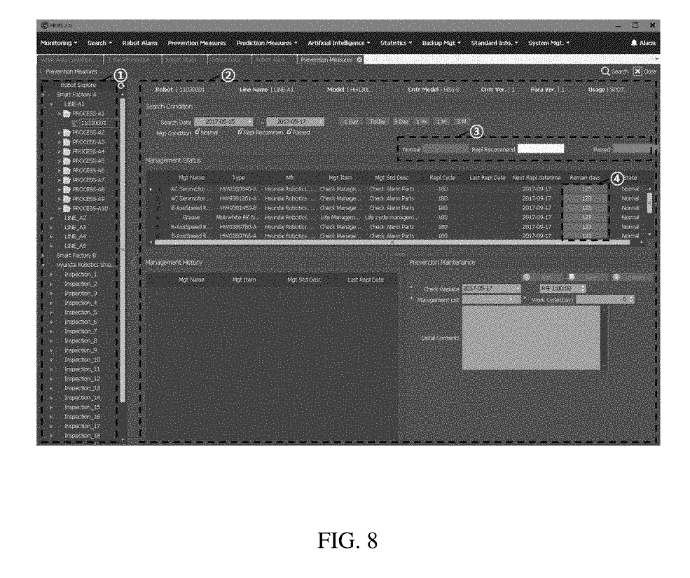

FIG. 8 is a diagram illustrating an example of a real-time robot monitoring program screen in which preventive measure information of a robot may be checked according to an embodiment of the present disclosure.

Referring to FIG. 8, the individual robot 100 disposed in a factory may be selected through the robot explore menu, as in \textcircled{1}, and preventive measure information of the selected robot 100 may be displayed, as in \textcircled{2}.

According to an embodiment, management state information of the robot 100 may be represented as one of a normal state (Normal), a replacement recommended state (Repl Recommend), and a passed state (Passed), as shown in \textcircled{3}, and each of the states is designated with a different color.

Accordingly, as shown in \textcircled{4}, a color corresponding to the management state of each of the axes of the robot 100 may be displayed so that a user may easily check the management state information of the robot 100.

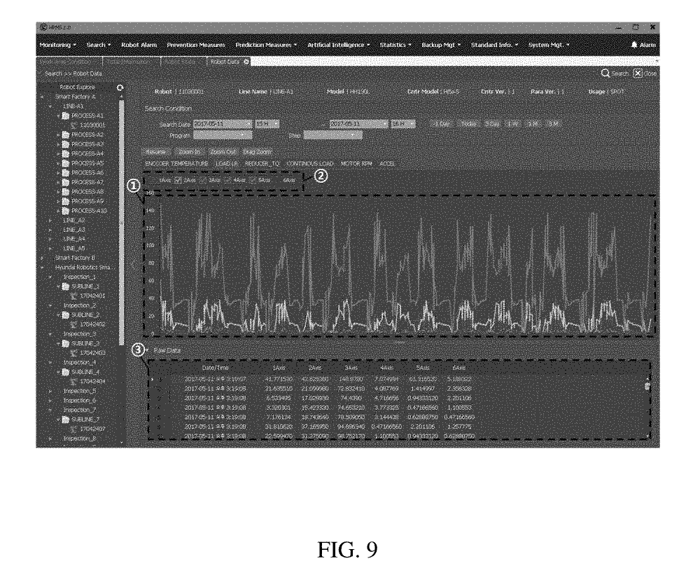

FIG. 9 is a diagram illustrating an example of a real-time robot monitoring program screen in which state change tendency information of each axis of a robot may be checked according to an embodiment of the present disclosure.

Referring to FIG. 9, the state change tendency for each of the axes of the robot 100 analyzed through the service providing server 300 may be represented in the form of a broken line graph, as shown in \textcircled{1}, and indicated with a different color for each of the axis, as shown in \textcircled{2}.

In addition, as shown in \textcircled{3}, detailed data on the state change tendency of each of the axes is arranged and displayed on the basis of time.

As such, according to an embodiment of the present disclosure, the service providing server 300 analyzes individual pieces of state information of the plurality of robots 100 that are acquired through an Internet of things (IoT) sensor in real-time such that defects in the robots 100 and a system abnormality are detected at an early stage and a possible failure is predicted and addressed so that a loss of a factory can be saved and stability and reliability of a system can be improved.

According to an embodiment of the present disclosure, the service providing server 300 is configured to automatically learn a state change pattern of the robot 100 when analyzing a state of each of the robots 100 so that service accuracy can be improved.

According to an embodiment of the present disclosure, the service providing server 300 collectively monitors the plurality of robots 100 held by a plurality of factories and provides each of the factories with a program in which statuses of the robots may be checked so that a cost of a factory for managing the robots 100 can be saved and convenience of management can be improved.

As should be apparent from the above, according to an embodiment of the present disclosure, the service providing server analyzes individual pieces of state information of the plurality of robots that are acquired through an Internet of things (IoT) sensor in real-time such that defects in the robots and a system abnormality are detected at an early stage and a possible failure is predicted and addressed so that a loss of a factory can be saved and stability and reliability of a system can be improved.

According to an embodiment of the present disclosure, the service providing server is configured to automatically learn a state change pattern of the robot when analyzing a state of each of the robots so that service accuracy can be improved.

According to an embodiment of the present disclosure, the service providing server collectively monitors the plurality of robots held by a plurality of factories and provides each of the factories with a program in which statuses of the robots may be checked so that a cost of a factory for managing the robots can be saved and convenience of management can be improved.

It should be understood that the advantageous effects of the present disclosure are not limited to the above, and all other effects provided from constructions disclosed in the specification or the scope of claims of the present disclosure are included therein.

The above description of the disclosure is for illustrative purposes, and a person having ordinary skilled in the art should appreciate that other specific modifications can be easily made without departing from the technical spirit or essential features of the disclosure. Therefore, the above embodiments should be regarded as illustrative rather than limitative in all aspects. For example, components which have been described as being a single unit can be embodied in a distributed form, whereas components which have been described as being distributed can be embodied in a combined form.

The scope of the present disclosure is not defined by the detailed description set forth above, but by the accompanying claims of the disclosure. It should also be understood that all changes or modifications derived from the definitions and scope of the claims and their equivalents fall within the scope of the disclosure.

What is claimed is:

1. A method of providing a real-time robot monitoring service, in which robots in a factory are monitored in real-time by a service providing server, the method comprising steps of:
(a) receiving state information of each axis of each of the robots from a robot controller;
(b) generating preventive measure information, which is related to a management state of the robot, and predictive measure information, which is related to a process capability of the robot and a state change pattern of the robot by analyzing the state information of each of the axes of the robot; and
(c) transmitting the preventive measure information of each of the axes and the predictive measure information of each of the axes to a terminal of a manager of the factory.

2. The method of claim 1, wherein the preventive measure information includes information related to at least one of a management state of each of the axes, a replacement recommended cycle of each of the axes s, a latest part replacement date of each axes s, and a remaining duration of each axes s.

3. The method of claim 1, wherein the predictive measure information includes information related to at least one of a state change tendency of each of the axes s, a process capability rank of each of the axes s, a remaining useful life of each of the axes s, and a state change pattern of each of the axes s.

4. The method of claim 3, wherein the process capability rank is assessed for each of the axes of the robot on the basis of a Zst value and a Zshift value of each of the axes calculated on the basis of the state information of each of the axes according to a predetermined process capability rating criterion.

5. The method of claim 4, wherein the process capability rating criterion assesses different process capability ranks within predetermined ranges of the Zst values and Zshift values such that a larger Zst value and a smaller Zshift value are assigned a higher process capability rank.

6. The method of claim 3, wherein, the process capability rating criterion is updated according to on-site information when on-site information is received from the terminal of the manager.

7. The method of claim 1, wherein step (b) further comprises, when the state change pattern is different from existing pattern information, learning a new state change pattern and allowing the new state change pattern to be used to analyze the state information of each of the axes.

8. The method of claim 1, wherein:
step (b) further comprises determining a corrective action according to a result of analyzing the state information of each of the axes s, and
step (c) further comprises transmitting the corrective action to the terminal of the manager.

9. The method of claim 1, wherein:
step (b) further comprises analyzing a cause and an action plan corresponding to an alarm signal received from the robot controller; and
step (c) further comprises transmitting information about the cause and the action plan corresponding to the alarm signal of the robot controller to the terminal of the manager of the factory.

10. The method of claim 1, wherein step (c) further comprises processing the preventive measure information and predictive measure information of each of the axes into a form of at least one of a graph or spreadsheet data.

11. A service providing server for monitoring robots in a factory in real time, the service providing server comprising:
a robot related information acquirer configured to receive state information of each axis of each robot from a robot controller;
a robot state diagnoser configured to generate preventive measure information which is related to a management state of the robot and predictive measure information which is related to a process capability and a state change pattern of the robot by analyzing the state information of each of the axes of the robot; and
a monitoring information provider configured to transmit the preventive measure information of each of the axes and the predictive measure information of each of the axes to a terminal of a manager of the factory.

12. The service providing server of claim 11, wherein the robot state analyzer is configured to, when the state change pattern is different from existing pattern information, learn a new state change pattern and allow the new state change pattern to be used to analyze the state information of each of the axes in the future.

13. The service providing server of claim 11, wherein:
the robot state diagnoser determines a corrective action according to a result of analyzing the state information of each of the axes, and
the monitoring information provider transmits the corrective action to the terminal of the manager.

14. The service providing server of claim 11, wherein:
the robot state diagnoser analyzes a cause and an action plan corresponding to an alarm signal received from the robot controller; and
the monitoring information provider transmits information about the cause and the action plan corresponding to the alarm signal of the robot controller to the terminal of the manager of the factory.

15. The service providing server of claim 11, wherein the monitoring information provider provides the preventive measure information and predictive measure information of each of the axes into a form of at least one of a graph or spreadsheet data.

16. A computer program stored in a recording medium to execute, in combination with a robot user terminal and a robot manufacturer terminal, steps of:
receiving state information of each axis of each of robots from a robot controller;
generating preventive measure information which is related to a management state of the robot and predictive measure information which is related to a process capability the robot and a state change pattern of the robot by analyzing the state information of each of the axes of the robot; and
transmitting the preventive measure information of each of the axes and the predictive measure information of each of the axes to the robot user terminal and the robot manufacturer terminal.
